(19) United States
(12) Patent Application Publication
(10) Pub. No.: US 2024/0372072 A1
(43) Pub. Date: Nov. 7, 2024

(54) NEGATIVE ACTIVE MATERIAL COMPOSITE, NEGATIVE ELECTRODE INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Jungho LEE, Yongin-si (KR); Youngugk KIM, Yongin-si (KR); Yookyung KIM, Yongin-si, Gyeonggi-do (KR); Sungwon JUNG, Yongin-si (KR); Jaehou NAH, Yongin-si (KR); Hyun SOH, Yongin-si, Gyeonggi-do (KR); Doori OH, Yongin-si, Gyeonggi-do (KR)

(21) Appl. No.: 18/383,660

(22) Filed: Oct. 25, 2023

(30) Foreign Application Priority Data
May 2, 2023 (KR) 10-2023-0057215

(51) Int. Cl. H01M 4/36; H01M 4/04; H01M 4/38; H01M 4/583; H01M 10/052

(52) U.S. Cl. CPC H01M 4/364; H01M 4/0471; H01M 4/386; H01M 4/583; H01M 10/052; H01M 2004/021; H01M 2004/027

(57) ABSTRACT

A negative electrode active material composite, including an amorphous carbon matrix, and silicon nanoparticles and crystalline carbon fibers dispersed in the amorphous carbon matrix, the silicon nanoparticles being in contact with a portion or all of the crystalline carbon fibers in the amorphous carbon matrix.

### CROSS-REFERENCE TO RELATED APPLICATION

This application claims priority to and the benefit of Korean Patent Application No. 10-2023-0057215, filed in the Korean Intellectual Property Office on May 2, 2023, the entire contents of which are incorporated herein by reference.

### BACKGROUND

### 1. Field

Embodiments relate to negative electrode active material composites, negative electrodes including the same, and rechargeable lithium batteries.

### 2. Description of the Related Art

Rechargeable lithium batteries are in the spotlight as power sources for driving medium to large devices such as hybrid vehicles and battery vehicles as well as small devices such as mobile phones, notebook computers, and smart phones. As a negative electrode active material for a rechargeable lithium battery, various types of carbon-based negative electrode active materials including artificial graphite, natural graphite, hard carbon, and the like capable of intercalating/deintercalating lithium are widely used. Recently, research on non-carbon-based negative electrode active materials such as silicon and tin to obtain higher capacity is being actively conducted.

### SUMMARY

Embodiments are directed to a negative electrode active material composite, including an amorphous carbon matrix, and silicon nanoparticles and crystalline carbon fibers dispersed in the amorphous carbon matrix, the silicon nanoparticles being in contact with a portion or all of the crystalline carbon fibers in the amorphous carbon matrix.

In embodiments an average particle diameter (D50) of the silicon nanoparticles may be about 50 nm to about 200 nm, and a maximum particle diameter (D max) may be about 80 nm to about 300 nm.

In embodiments an aspect ratio of the silicon nanoparticles may be about 1 to about 20.

In embodiments a full width at half maximum of an X-ray diffraction angle using CuKα ray at the (111) plane of the silicon nanoparticles may be about 0.3° to about 1.0°.

In embodiments an average particle diameter (D50) of the crystalline carbon fibers may be about 0.5 μm to about 3.0 μm, and a maximum particle diameter (D max) may be about 3.0 μm to about 5.0 μm.

In embodiments an aspect ratio of the crystalline carbon fibers may be about 5 to about 300.

In embodiments a thickness of the crystalline carbon fibers may be about 10 nm to about 100 nm.

In embodiments when measured by XRD for the crystalline carbon fiber, an interplanar spacing d002 of the (002) plane may be about 0.3354 nm to about 0.3365 nm.

In embodiments in Raman spectrum analysis of the crystalline carbon fiber, a peak intensity ratio (ID/IG) of a peak intensity (ID) of a D peak (1350 to 1370 cm−1) to a peak intensity (ID′) of a G peak (1570 to 1620 cm−1) may be about 0.2 to about 0.5.

In embodiments the amorphous carbon matrix may include soft carbon, hard carbon, a mesophase pitch carbonized product, calcined coke, or a mixture thereof.

In embodiments the negative electrode active material composite may include the silicon nanoparticles and the crystalline carbon fibers in a weight ratio of greater than or equal to about 2.

In embodiments, based on a total weight of the negative electrode active material composite, the silicon nanoparticles may be included in an amount of about 40 wt % to about 70 wt %, the crystalline carbon fibers may be included in an amount of about 1 wt % to about 20 wt %, and the amorphous carbon matrix may be included in an amount of about 10 wt % to about 50 wt %.

In embodiments an average particle diameter (D50) of the negative electrode active material composite may be about 7 μm to about 15 μm, and a maximum particle diameter (D max) may be about 10 μm to about 30 μm.

In embodiments an internal pore diameter of the negative electrode active material composite may be about 5 nm to about 50 nm.

In embodiments a BET specific surface area of the negative electrode active material composite may be about 0.1 m²/g to about 5 m²/g.

Embodiments are directed to a method of manufacturing a negative electrode active material composite, including mixing silicon nanoparticles with crystalline carbon fibers, processing the mixture into a silicon nanoparticle-crystalline carbon fiber composite precursor, and heat-treating the silicon nanoparticle-crystalline carbon fiber composite precursor and the amorphous carbon precursor in a nitrogen atmosphere to manufacture a negative electrode active material composite.

Embodiments are directed to a negative electrode for a rechargeable lithium battery, including a current collector and a negative electrode active material layer on the current collector, the negative electrode active material layer may include the negative electrode active material composite.

In embodiments if a rechargeable lithium battery including the negative electrode is subjected to 100 cycles as one cycle of charging with a constant current to 4.2 V at a rate of 0.5 C and discharging with a constant current to 2.5 V at a rate of 0.5 C, the negative electrode may have a thickness expansion rate of according to Equation 1 of less than or equal to about 20%,

$$Negative electrode thickness expansion rate [ \% ] = \qquad [ Equation 1 ]$$

$$[ negative electrode thickness after 100 cycles /$$

$$negative electrode thickness at first cycle ] \times 100.$$

Embodiments are directed to a positive electrode, a negative electrode, and an electrolyte, wherein the negative electrode may be the negative electrode from example embodiments.

### BRIEF DESCRIPTION OF THE DRAWINGS

Features will become apparent to those of skill in the art by describing in detail exemplary embodiments with reference to the attached drawings in which:

FIG. 1 shows a schematic view of a negative electrode active material composite according to some example embodiments;

FIG. 2 is a SEM image of a negative electrode active material composite according to one example; and

FIG. 3 is a SEM image of a negative electrode active material composite according to comparative example.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if/when a layer or element is referred to as being “on” another layer or substrate, it can be directly on the other layer or substrate, or intervening layers may also be present. Further, it will be understood that if/when a layer is referred to as being “under” another layer, it can be directly under, and one or more intervening layers may also be present. In addition, it will also be understood that if/when a layer is referred to as being “between” two layers, it can be the only layer between the two layers, or one or more intervening layers may also be present. Like reference numerals refer to like elements throughout.

As used herein, “a combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, “layer” herein includes not only a shape formed on the whole surface if/when viewed from a plan view, but also a shape formed on a partial surface.

In addition, “particle diameter” or “average particle diameter” may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of about 50 volume % in the particle size distribution.

“Thickness” may be measured through a picture taken with an optical microscope such as a scanning electron microscope.

### Negative Electrode Active Material Composite

As described above, in order to improve low capacity of a carbon-based negative electrode active material (artificial graphite, natural graphite, hard carbon, etc.), a non-carbon-based negative electrode active material (silicon, tin, etc.), a high-capacity material, is being actively researched.

However, the non-carbon-based negative electrode active material inevitably undergoes a phase transition (phase transformation) during the intercalation and deintercalation process, resultantly having an extreme volume change. This may cause expansion of a negative electrode, leading to shortening a cycle-life of a rechargeable lithium battery.

In addition, as the non-carbon-based negative electrode active material repeats expansion and contraction, SEI may grow on the interface of the non-carbon-based negative electrode active material and a liquid electrolyte, which may further sharply decrease or shorten the cycle-life of the rechargeable lithium battery.

Furthermore, the non-carbon-based negative electrode active material may have lower electrical conductivity than the carbon-based negative electrode active material. In this regard, an attempt to combine the non-carbon-based negative electrode active material with the carbon-based negative electrode active material has been made to secure high rate and output characteristics of the rechargeable lithium battery.

For example, technology of mixing or coating a type of the non-carbon-based negative electrode active material, silicon (Si), with a type of the carbon-based negative electrode active material, graphite, has been proposed. However, since the graphite inherently has a spherical shape, a large amount of pores may be produced between graphite and silicon, into which the liquid electrolyte is impregnated, deteriorating the cycle-life of the rechargeable lithium battery.

In order to solve this problem, some example embodiments may provide a negative electrode active material composite including amorphous carbon matrix; and silicon nanoparticles and crystalline carbon fibers dispersed in the amorphous carbon matrix, wherein a portion or all of the silicon nanoparticles may be present in contact with a portion all of the crystalline carbon fibers.

Thereby, provided is a rechargeable lithium battery with excellent capacity characteristics, rate capability, and cycle-life characteristics, compared to the case where silicon nanoparticles are used alone or in combination with graphite.

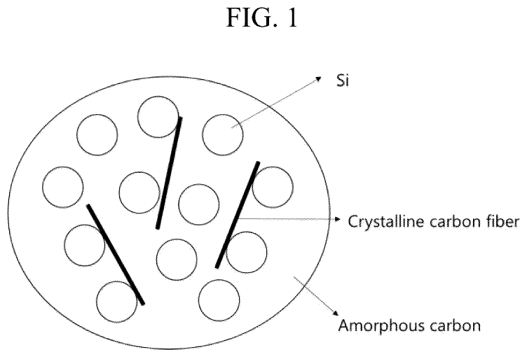

For example, FIG. 1 shows a schematic view of a negative electrode active material composite according to some example embodiments.

The example embodiments may use crystalline carbon fibers having a plane-like shape instead of graphite having a spherical shape and small silicon nanoparticles having an average particle diameter (D₅₀) having several to hundreds of nano meters. Accordingly, the cycle-life deterioration of the rechargeable lithium battery may be suppressed by increasing a contact area between the crystalline carbon fibers and the silicon nanoparticles and minimizing the pores therebetween.

In addition, in the example embodiments, the crystalline carbon fibers and the silicon nanoparticles may be dispersed in the amorphous matrix. Accordingly, the amorphous matrix may be filled in the empty spaces between the crystalline carbon fiber and the silicon nanoparticles to further lower porosity of the final composite and thus suppress the cycle-life deterioration of the rechargeable lithium battery.

Furthermore, in some example embodiments, a portion or all of the silicon nanoparticles may be present in contact with a portion all of the crystalline carbon fibers. Since the electrical conductivity of the crystalline carbon fibers is equivalent to that of the graphite, it may be possible to secure rate capability of a rechargeable lithium battery by forming a dense electrically conductive network as described above.

Hereinafter, the negative electrode active material composite of the embodiment is described in detail.

### Silicon Nanoparticles

In the negative electrode active material composite of the embodiment, the silicon nanoparticles may be a component contributing to increasing capacity of the rechargeable lithium battery.

An average particle diameter (D₅₀) of the silicon nanoparticles may be about 50 to about 200 nm, and a maximum particle diameter (Dₘₐₓ) may be about 80 to about 300 nm. In an implementation, the average particle diameter (D₅₀) of the silicon nanoparticles may be greater than or equal to about 50 nm, greater than or equal to about 60 nm, greater than or equal to about 70 nm, or greater than or equal to about 80 nm, and less than or equal to about 200 nm, less than or equal to about 150 nm, less than or equal to about 140 nm, less than or equal to about 130 nm, or less than or equal to about 115 nm. In addition, the maximum particle diameter (Dₘₐₓ) of the silicon nanoparticles may be greater than or equal to about 80 nm, greater than or equal to about 90 nm, greater than or equal to about 100 nm, or greater than or equal to about 110 nm, and less than or equal to about 300 nm, less than or equal to about 250 nm, less than or equal to about 240 nm, less than or equal to about 230 nm, or less than or equal to about 215 nm. Within these ranges, the side reaction between the silicon nanoparticles and the electrolyte may be suppressed, and the expansion of the silicon nanoparticles may be reduced, thereby improving initial efficiency and cycle-life characteristics of the rechargeable lithium battery.

A short axis length (a) of the silicon nanoparticles may be about 10 nm to about 70 nm, and a long axis length (b) of the silicon nanoparticles may be about 70 nm to about 200 nm. An aspect ratio (b/a) of the silicon nanoparticles may be about 1 to about 20. In an implementation, the aspect ratio of the silicon nanoparticles may be greater than or equal to about 1, greater than or equal to about 2, greater than or equal to about 3, or greater than or equal to about 4, and less than or equal to about 20, less than or equal to about 18, less than or equal to about 16, or less than or equal to about 14. If the long axis length (b), short axis length (a), and aspect ratio (b/a) of the silicon nanoparticles each fall within the above ranges, side reactions between the silicon nanoparticles and the electrolyte may be suppressed, and the expansion of the silicon nanoparticles may be reduced, so that initial efficiency and cycle-life characteristics of the rechargeable lithium battery may be improved.

A full width at half maximum of an X-ray diffraction angle (2theta) using CuKα ray at the (111) plane of the silicon nanoparticles may be about 0.3 to about 1.0°. Within this range, cycle-life characteristics of the rechargeable lithium battery may be improved. The full width at half maximum of the X-ray diffraction angle (2theta) using CuKα ray at the (111) plane of the silicon nanoparticles may be achieved by adjusting the particle size of the silicon nanoparticles or changing the silicon nanoparticle preparing process.

### Crystalline Carbon Fiber

In the negative electrode active material of some example embodiments, the crystalline carbon fibers may be a component that has electrical conductivity equivalent to that of graphite to secure rate capability of a rechargeable lithium battery, and lowers a porosity of the negative electrode active material composite to prevent deterioration in cycle-life of a rechargeable lithium battery.

An average particle diameter (D₅₀) of the crystalline carbon fibers may be about 0.5 to about 3.0 μm, and a maximum particle diameter (Dₘₐₓ) may be about 3.0 to about 5.0 μm. In an implementation, the average particle diameter (D₅₀) of the crystalline carbon fibers may be greater than or equal to about 0.5 μm, greater than or equal to about 0.6 μm, greater than or equal to about 0.7 μm, or greater than or equal to about 1 μm and less than or equal to about 3.0 μm, less than or equal to about 2.9 μm, less than or equal to about 2.8 μm, less than or equal to about 2.7 μm, or less than or equal to about 2.6 μm. In addition, the maximum particle diameter (Dₘₐₓ) of the crystalline carbon fibers may be greater than or equal to about 3.0 μm, greater than or equal to about 3.2 μm, greater than or equal to about 3.4 μm, or greater than or equal to about 3.6 μm and less than or equal to about 5.0 μm, less than or equal to about 4.8 μm, less than or equal to about 4.6 μm, less than or equal to about 4.4 μm or less than or equal to about 4.2 μm. Within this range, the porosity of the negative electrode active material composite may be minimized and cycle-life deterioration of the rechargeable lithium battery may be suppressed.

A short axis length (a) of the crystalline carbon fibers may be about 10 to about 100 nm, and a long axis length (b) may be about 0.5 to about 3.0 μm. An aspect ratio (b/a) of the crystalline carbon fibers may be about 5 to about 300. In an implementation, the aspect ratio of the crystalline carbon fibers may be greater than or equal to about 5, greater than or equal to about 10, greater than or equal to about 15, or greater than or equal to about 20 and less than or equal to about 300, less than or equal to about 250, or less than or equal to about 200. If the long axis length (b), short axis length (a), and aspect ratio (b/a) of the crystalline carbon fibers fall within the above ranges, the porosity of the negative electrode active material composite may be minimized and cycle-life deterioration of the rechargeable lithium battery may be suppressed.

A thickness of the crystalline carbon fibers may be about 10 to about 100 nm. In an implementation, the thickness of the crystalline carbon fibers may be greater than or equal to about 10 nm, greater than or equal to about 11 nm, greater than or equal to about 12 nm, or greater than or equal to about 13 nm and less than or equal to about 100 nm, less than or equal to about 90 nm, less than or equal to about 80 nm, less than or equal to about 70 nm, or less than or equal to about 60 nm. Within this range, the porosity of the negative electrode active material composite may be minimized and cycle-life deterioration of the rechargeable lithium battery may be suppressed.

If measured by XRD for the crystalline carbon fiber, an interplanar spacing d002 of the (002) plane may be about 0.3354 to about 0.3365 nm. In an implementation, the interplanar spacing d002 may be greater than or equal to about 0.3354 nm, greater than or equal to about 0.3355 nm, greater than or equal to about 0.3356 nm, greater than or equal to about 0.3357 nm, or greater than or equal to about 0.3358 nm and less than or equal to about 0.3365 nm, less than or equal to about 0.3364 nm, less than or equal to about 0.3363 nm, less than or equal to about 0.3362 nm, or less than or equal to about 0.3361 nm. Within this range, the negative electrode active material composite may improve the initial efficiency and capacity of the rechargeable lithium battery with excellent electrical conductivity and suppress initial deterioration.

In Raman spectrum analysis of the crystalline carbon fiber, a peak intensity ratio (I_{D}/I_{G}) of a peak intensity (I_{D}) of a D peak (1350 to 1370 cm⁻¹) to a peak intensity (I_{D′}) of a G peak (1570 to 1620 cm⁻¹) may be about 0.2 to about 0.5. Within this range, the negative electrode active material composite may improve initial efficiency and capacity of the rechargeable lithium battery with excellent electrical conductivity, and may suppress initial deterioration. In particular, although the thickness is 1/100 of that of graphite, the interplanar spacing and Raman peak intensity ratio for evaluating crystallinity may be similar to graphite, and thus the porosity of the negative electrode active material composite may be greatly decreased, while the electrical conductivity may be increased to the same level as graphite. Accordingly, the negative electrode active material composite may secure long-term cycle-life by suppressing permeation of liquid electrolyte while securing electrical conductivity.

### Amorphous Carbon

In the negative electrode active material composite of the embodiment, the amorphous carbon matrix may suppress direct contact between the silicon nanoparticles and the electrolyte, reduce side reactions between them, and secure cycle-life characteristics of the rechargeable lithium battery. In addition, the amorphous carbon may serve as a binder that binds the silicon nanoparticles to each other, the crystalline carbon fibers to each other, and the silicon nanoparticles and the crystalline carbon fibers to prevent the negative electrode active material composite from being broken and to maintain its shape well.

The amorphous carbon matrix may include at least one amorphous carbon, e.g., soft carbon, hard carbon, a mesophase pitch carbonized product, calcined coke, or a mixture thereof. Since such amorphous carbon may have a low melting point compared to crystalline carbon, it may have excellent fluidity during heat treatment and may be effective in filling internal pores by flowing into the inside. In addition, amorphous carbon may have an advantage in output characteristics because diffusion of lithium ions may be more advantageous than crystalline carbon. As used herein, the term “or” is not an exclusive term, e.g., “A or B” would include A, B, or A and B

### Negative Electrode Active Material Composite

As described above, the negative electrode active material composite of some example embodiments may include an amorphous carbon matrix; and silicon nanoparticles and crystalline carbon fibers dispersed in the amorphous carbon matrix, thereby supplementing disadvantages of each component while taking advantages to implement a rechargeable lithium battery with excellent capacity characteristics, rate capability, and cycle-life characteristics.

The negative electrode active material composite may include the silicon nanoparticles/the crystalline carbon fibers in a weight ratio (silicon nanoparticles: crystalline carbon fibers) of greater than or equal to about 2, greater than or equal to about 4, or greater than or equal to about 9. Within the above range, a capacity improvement effect of the rechargeable lithium battery by the silicon nanoparticles and the rate capability and cycle-life securing effect of the rechargeable lithium battery by the crystalline carbon fibers may be harmonized.

Furthermore, based on a total weight of the negative electrode active material composite, the silicon nanoparticles may be included in an amount of about 40 to about 70 wt %, about 20 to about 60 wt %, or about 40 to about 55 wt %, the crystalline carbon fibers may be included in an amount of about 1 to about 20 wt %, about 2 to about 10 wt %, or about 3 to about 5 wt %, and the amorphous carbon matrix may be included in an amount of about 10 to about 50 wt %, about 15 to about 45 wt %, or about 20 to about 40 wt %. Within the above range, a capacity improvement effect of the rechargeable lithium battery by the silicon nanoparticles, the rate capability and cycle-life securing effect of the rechargeable lithium battery by the crystalline carbon fibers and the amorphous carbon matrix may be harmonized.

An average particle diameter (D₅₀) of the negative electrode active material composite may be about 7 μm to about 15 μm, and a maximum particle diameter (Dₘₐₓ) may be about 10 μm to about 30 μm. In an implementation, the average particle diameter (D₅₀) of the composite may be greater than or equal to about 7 μm, greater than or equal to about 8 μm, greater than or equal to about 9 μm, or greater than or equal to about 10 μm, and less than or equal to about 15 μm, less than or equal to about 14 μm, less than or equal to about 13 μm, less than or equal to about 12 μm, or less than or equal to about 11 μm. In addition, the maximum particle diameter (Dₘₐₓ) of the composite may be greater than or equal to about 10 μm, greater than or equal to about 11 μm, greater than or equal to about 12 μm, or greater than or equal to about 13 μm, and less than or equal to about 30 μm, less than or equal to about 28 μm, less than or equal to about 26 μm, less than or equal to about 24 μm, or less than or equal to about 22 μm. Within these ranges, an excessive increase in the specific surface area of the negative electrode active material composite may be suppressed to reduce side reactions with the electrolyte, and to improve rate capability while suppressing a resistance of the rechargeable lithium battery.

Pores having a diameter of about 5 to about 50 nm may be included inside the negative electrode active material composite, and a pore volume of internal pores having the diameter may be greater than or equal to about 0.1×10⁻² and less than 5.0×10⁻² cm³/g. In an implementation, the internal pore diameter of the composite may be greater than or equal to about 5 nm, greater than or equal to about 6 nm, greater than or equal to about 7 nm, greater than or equal to about 8 nm, greater than or equal to about 9 nm, or greater than or equal to about 10 nm and less than or equal to about 50 nm, less than or equal to about 45 nm, less than or equal to about 40 nm, less than or equal to about 35 nm, or less than or equal to about 30 nm. In addition, a volume of the internal pores having the diameter may be greater than or equal to about 0.1×10⁻² cm³/g, greater than or equal to about 0.2×10⁻² cm³/g, greater than or equal to about 0.3×10⁻² cm³/g, or greater than or equal to about 0.5×10⁻² cm³/g and less than about 5.0×10⁻² cm³/g, less than or equal to about 4.5×10⁻² cm³/g, less than or equal to about 4.0×10⁻² cm³/g, less than or equal to about 3.5×10⁻² cm³/g, or less than or equal to about 3.0×10⁻² cm³/g. If the diameter and volume of the internal pores inside the negative electrode active material composite satisfy the aforementioned ranges, the side reaction between the silicon nanoparticles included in the composite and the electrolyte may be suppressed, and the expansion of the silicon nanoparticles may be reduced, thereby improving initial efficiency and cycle-life characteristics of rechargeable lithium battery. The volume of the internal pores having the above diameter may be quantitatively measured using a Barrett-Joyner-Halenda (BJH) analysis equipment.

The negative electrode active material composite may have a BET specific surface area of about 0.1 to about 5 m²/g. In an implementation, the composite may have a BET specific surface area of greater than or equal to about 0.1 m²/g, greater than or equal to about 0.5 m²/g, greater than or equal to about 1 m²/g, greater than or equal to about 1.5 m²/g, or greater than or equal to about 2 m²/g and less than or equal to about 5 m²/g, less than or equal to about 4.5 m²/g, less than or equal to about 4 m²/g, less than or equal to about 3.5 m²/g, less than or equal to about 3 m²/g, or less than or equal to about 2.5 m²/g. Within this range, an excessive increase in the specific surface area of the composite may be suppressed to reduce side reactions with the electrolyte, and rate capability may be improved while suppressing resistance of the rechargeable lithium battery.

### Method of Manufacturing Negative Electrode Active Material Composite

In some example embodiments, a method of manufacturing a negative electrode active material composite may include mixing silicon nanoparticles with crystalline carbon fibers; processing the mixture into a silicon nanoparticle-crystalline carbon fiber composite precursor; and the silicon nanoparticles-crystalline carbon fiber composite precursor and heat-treating the silicon nanoparticle-crystalline carbon fiber composite precursor and the amorphous carbon precursor in a nitrogen atmosphere to manufacture a negative electrode active material composite.

If the silicon nanoparticles are mixed with the crystalline carbon fibers, the silicon nanoparticles/the crystalline carbon fibers may be included in a weight ratio (silicon nanoparticles: crystalline carbon fibers) of greater than or equal to about 2, greater than or equal to about 4, or greater than or equal to about 9. Within the above range, a capacity improvement effect of the rechargeable lithium battery by the silicon nanoparticles and the rate capability and cycle-life securing effect of the rechargeable lithium battery by the crystalline carbon fibers may be harmonized.

If the mixture is processed with the silicon nanoparticles-crystalline carbon fiber composite precursor, a spray drying method, a sol-gel method, or a vapor deposition method may be adopted.

If the silicon nanoparticles-crystalline carbon fiber composite precursor and the amorphous carbon precursor are heat-treated under a nitrogen atmosphere, since the amorphous carbon precursor may be converted into an amorphous carbon matrix, the silicon nanoparticles may be present in contact with a portion or all of the crystalline carbon fibers in the amorphous carbon matrix.

### Negative Electrode

In some example embodiments, a negative electrode for a rechargeable lithium battery may include a current collector and a negative electrode active material layer on the current collector, wherein the negative electrode active material layer may include the negative electrode active material composite according to the aforementioned embodiment.

As the negative electrode of the aforementioned embodiments may include the negative electrode active material composite of the aforementioned embodiment, capacity characteristics, rate capability, and cycle-life characteristics of the rechargeable lithium battery may be simultaneously secured. Hereinafter, descriptions overlapping with the above will be omitted, and configurations other than the negative electrode active material will be described.

### Current Collector

The current collector may include, e.g., a copper foil, a nickel foil, a stainless steel foil, a titanium foil, a nickel foam, a copper foam, a polymer substrate coated with a conductive metal, or a combination thereof.

### Negative Electrode Active Material Layer

The negative electrode active material layer essentially includes the negative electrode active material composite of the aforementioned embodiment, and may optionally further include a negative electrode active material different from the negative electrode active material composite of the aforementioned embodiments.

The negative electrode active material different from the negative electrode active material composite of the aforementioned embodiment may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include, e.g., crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy includes an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q may be an alkali metal, an alkaline-earth metal, a Group 13 element, a Group 14 element, a Group 15 element, a Group 16 element, a transition metal, a rare earth element, or a combination thereof, but not Si) and the Sn-based negative electrode active material may include Sn, SnO₂, Sn—R alloy (wherein R may be an alkali metal, an alkaline-earth metal, a Group 13 element, a Group 14 element, a Group 15 element, a Group 16 element, a transition metal, a rare earth element, or a combination thereof, but not Sn). At least one of these materials may be mixed with SiO₂. The elements Q and R may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be about 10 wt % to about 50 wt % based on a total weight of the silicon-carbon composite. In addition, the content of the crystalline carbon may be about 10 wt % to about 70 wt % based on a total weight of the silicon-carbon composite, and the content of the amorphous carbon may be about 20 wt % to about 40 wt % based on a total weight of the silicon-carbon composite. In addition, a thickness of the amorphous carbon coating layer may be about 5 nm to about 100 nm. An average particle diameter (D₅₀) of the silicon particles may be about 10 nm to about 20 μm. The average particle diameter (D₅₀) of the silicon particles may be preferably about 10 nm to about 200 nm. The silicon particles may exist in an oxidized form, and in this case, an atomic content ratio of Si:O in the silicon particles indicating a degree of oxidation may be a weight ratio of about 99:1 to about 33:67. The silicon particles may be SiOₓ particles, and in this case, the range of x in SiOₓ may be greater than about 0 and less than about 2. As used herein, if a definition is not otherwise provided, an average particle diameter (D₅₀) indicates a particle where an accumulated volume is about 50 volume % in a particle distribution.

The Si-based negative electrode active material or Sn-based negative electrode active material may be mixed with the carbon-based negative electrode active material. If the Si-based negative electrode active material or Sn-based negative electrode active material and the carbon-based negative electrode active material are mixed and used, the mixing ratio may be a weight ratio of about 1:99 to about 90:10.

In the negative electrode active material layer, the negative electrode active material may be included in an amount of about 95 wt % to about 99 wt % based on a total weight of the negative electrode active material layer.

In some example embodiments, the negative electrode active material layer may further include a binder, and may optionally further include a conductive material. The content of the binder in the negative electrode active material layer may be about 1 wt % to about 5 wt % based on a total weight of the negative electrode active material layer. In addition, if the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder may serve to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be, e.g., styrene-butadiene rubber, an acrylated styrene-butadiene rubber, an acrylonitrile-butadiene rubber, an acrylic rubber, a butyl rubber, a fluororubber, or a combination thereof. The polymer resin binder may be, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

If a water-soluble binder is used as the negative electrode binder, a cellulose-based compound capable of imparting viscosity as a thickener may be further included. As the cellulose-based compound, one or more of carboxymethyl cellulose, hydroxypropylmethyl cellulose, methyl cellulose, or alkali metal salts thereof may be mixed and used. As the alkali metal, Na, K, or Li may be used. The amount of such a thickener used may be about 0.1 parts by weight to about 3 parts by weight based on 100 parts by weight of the negative electrode active material.

The conductive material may be included to provide electrode conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative current collector may include, e.g., a copper foil, a nickel foil, a stainless steel foil, a titanium foil, a nickel foam, a copper foam, a polymer substrate coated with a conductive metal, or a combination thereof.

### Rechargeable Lithium Battery

In some example embodiments, a rechargeable lithium battery may include a positive electrode; a negative electrode; and an electrolyte, wherein the negative electrode may be the negative electrode of the aforementioned embodiments.

As the rechargeable lithium battery of the embodiment may include the negative electrode of the aforementioned embodiment, capacity characteristics, rate capability, and cycle-life characteristics of the rechargeable lithium battery may be simultaneously secured. Hereinafter, descriptions overlapping with those described above will be omitted, and configurations other than the negative electrode will be described.

### Positive Electrode

The positive electrode may include a current collector and a positive electrode active material layer on the current collector. According to some example embodiments, the positive electrode may have a structure in which a current collector, a positive electrode active material layer, a functional layer, and an adhesive layer are stacked in this order.

The positive electrode active material layer may include a positive electrode active material, and may further include a binder and/or a conductive material.

The positive electrode active material may include lithiated intercalation compounds that reversibly intercalate and deintercalate lithium ions. Examples of the positive electrode active material may include a compound represented by any one of the following chemical formulas:

LiₐA_{1-b}X_{b}D₂(0.90≤a≤1.8, 0≤b≤0.5);

LiₐA_{1-b}X_{b}O_{2-c}D_{c}(0.90≤a≤1.8, 0≤b≤0.5, 0≤c≤0.05);

LiₐE_{1-b}X_{b}O_{2-c}D_{c}(0.90≤a≤1.8, 0≤b≤0.5, 0≤c≤0.05);

LiₐE_{2-b}X_{b}O_{4-c}D_{c}(0.90≤a≤1.8, 0≤b≤0.5, 0≤c≤0.05);

LiₐNi_{1-b-c}Co_{b}X_{c}D_{α}(0.90≤a≤1.8, 0≤b≤0.5, 0≤c≤0.5, 0<α≤2);

LiₐNi_{1-b-c}Co_{b}X_{c}O_{2-α}T_{α}(0.90≤a≤1.8, 0≤b≤0.5, 0≤c≤0.05, 0<α<2);

LiₐNi_{1-b-c}Co_{b}X_{c}O_{2-α}T₂(0.90≤a≤1.8, 0≤b≤0.5, 0≤c≤0.05, 0<α<2);

LiₐNi_{1-b-c}Mn_{b}X_{c}D_{α}(0.90≤a≤1.8, 0≤b≤0.5, 0≤c≤0.05, 0<α≤2);

LiₐNi_{1-b-c}Mn_{b}X_{c}O_{2-α}T_{α}(0.90≤a≤1.8, 0≤b≤0.5, 0≤c≤0.05, 0<α<2);

LiₐNi_{1-b-c}Mn_{b}X_{c}O_{2-α}T₂(0.90≤a≤1.8, 0≤b≤0.5, 0≤c≤0.05, 0<α<2);

LiₐNi_{b}E_{c}G_{d}O₂(0.90≤a≤1.8, 0≤b≤0.9, 0≤c≤0.5, 0.001≤d≤0.1);

LiₐNi_{b}Co_{c}Mn_{d}GₑO₂(0.90≤a≤1.8, 0≤b≤0.9, 0≤c≤0.5, 0≤d≤0.5, 0.001≤e≤0.1);

LiₐNiG_{b}O₂(0.90≤a≤1.8, 0.001≤b≤0.1);

LiₐCoG_{b}O₂(0.90≤a≤1.8, 0.001≤b≤0.1);

LiₐMn_{1-b}G_{b}O₂(0.90≤a≤1.8, 0.001≤b≤0.1);

LiₐMn₂G_{b}O₄(0.90≤a≤1.8, 0.001≤b≤0.1);

LiₐMn_{1-g}G_{g}PO₄(0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof; D may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z may be, e.g., Cr, V, Fe, Sc, Y, or a combination thereof; and J may be, e.g., V, Cr, Mn, Co, Ni, Cu, or a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, or a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. In the coating layer forming process, a method that does not adversely affect the physical properties of the positive electrode active material, e.g., spray coating, dipping, and the like may be used.

The positive electrode active material may include, e.g., a lithium nickel composite oxide represented by Chemical Formula 11.

Liₐ₁₁Niₓ₁₁M¹¹_{y11}M¹²_{1-11-y12}O₂ [Chemical Formula 11]

In Chemical Formula 11, 0.9≤a11≤1.8, 0.3≤x11≤1, 0≤y11≤0.7, and M¹¹ and M¹² may each independently be Al, B, Ce, Co, Cr, F, Mg, Mn, Mo, Nb, P, S, Si, Sr, Ti, V, W, Zr, or a combination thereof.

In Chemical Formula 11, 0.4≤x11≤1 and 0≤y11≤0.6, 0.5≤x11≤1 and 0≤y11≤0.5, 0.6≤x11≤1 and 0≤y11≤0.4, or 0.7≤x11≤1 and 0≤y11≤0.3, 0.8≤x11≤1 and 0≤y11≤0.2, or 0.9≤x11≤1 and 0≤y11≤0.1.

As a specific example, the positive electrode active material may include a lithium nickel cobalt composite oxide represented by Chemical Formula 12.

Liₐ₁₂Niₓ₁₂Co_{y12}M¹³_{1-x12-y12}O₂ [Chemical Formula 12]

In Chemical Formula 12, 0.9≤a12≤1.8, 0.3≤x12<1, 0<y12≤0.7, and M¹³ may be Al, B, Ce, Cr, F, Mg, Mn, Mo, Nb, P, S, Si, Sr, Ti, V, W, Zr, or a combination thereof.

In Chemical Formula 12, 0.3≤x12≤0.99 and 0.01≤y12≤0.7, 0.4≤x12≤0.99 and 0.01≤y12≤0.6, 0.5≤x12≤0.99 and 0.01≤y12≤0.5, 0.6≤x12≤0.99 and 0.01≤y12≤0.4, 0.7≤x12≤0.99 and 0.01≤y12≤0.3, 0.8≤x12≤0.99 and 0.01≤y12≤0.2, or 0.9≤x12≤0.99 and 0.01≤y12≤0.1.

As a specific example, the positive electrode active material may include a lithium nickel cobalt composite oxide represented by Chemical Formula 13.

Liₐ₁₃Niₓ₁₃Co_{y13}M¹⁴_{z13}M¹⁵_{1-x13-y13-z13}O₂ [Chemical Formula 3]

In Chemical Formula 13, 0.9≤a13≤1.8, 0.3≤x13≤0.98, 0.01≤y13≤0.69, 0.01≤z13≤0.69, M¹⁴ may be Al, Mn, or a combination thereof, and M¹⁵ may be B, Ce, Cr, F, Mg, Mo, Nb, P, S, Si, Sr, Ti, V, W, Zr, or a combination thereof.

In Chemical Formula 13, 0.4≤x13≤0.98, 0.01≤y13≤0.59, and 0.01≤z13≤0.59, 0.5≤x13≤0.98, 0.01≤y13≤0.49, and 0.01≤z13≤0.49, or 0.6≤x13≤0.98, 0.01≤y13≤0.39, and 0.01≤z13≤0.39, or 0.7≤x13≤0.98, 0.01≤y13≤0.29, and 0.01≤z13≤0.29, 0.8≤x13≤0.98, 0.01≤y13≤0.19, and 0.01≤z13≤0.19, or 0.9≤x13≤0.98, 0.01≤y13≤0.09, and 0.01≤z13≤0.09.

The content of the cathode active material may be about 90 wt % to about 98 wt %, or, e.g., about 90 wt % to about 95 wt %, based on a total weight of the positive electrode active material layer. Each content of the binder and the conductive material may be about 1 wt % to about 5 wt %, based on a total weight of the positive electrode active material layer.

The binder may improve binding properties of positive electrode active material particles with one another and with a current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may be included to provide electrode conductivity. Any electrically conductive material may be used as a conductive material unless it causes a chemical change. Examples of the conductive material may include a carbon-based material such as natural graphite, artificial graphite, carbon black, acetylene black, ketjen black, a carbon fiber, or the like; a metal-based material of a metal powder or a metal fiber including copper, nickel, aluminum, silver, and the like; a conductive polymer such as a polyphenylene derivative; or a mixture thereof.

An aluminum foil may be used as the positive current collector.

### Separator

The separator may separate a positive electrode and a negative electrode and may provide a transporting passage for lithium ions and may be any generally-used separator in a lithium ion battery. In other words, it may have low resistance to ion transport and excellent impregnation for an electrolyte. In an implementation, the separator may be, e.g., a glass fiber, polyester, Teflon, polyethylene, polypropylene, polytetrafluoroethylene, or a combination thereof. It may have a form of a non-woven fabric or a woven fabric. In an implementation, in a lithium ion battery, a polyolefin-based polymer separator such as polyethylene and polypropylene may be mainly used. In order to ensure the heat resistance or mechanical strength, a coated separator including a ceramic component or a polymer material may be used. Optionally, it may have a mono-layered or multi-layered structure.

### Electrolyte

The electrolyte may include a non-aqueous organic solvent and a lithium salt.

The non-aqueous organic solvent may serve as a medium for transmitting ions taking part in the electrochemical reaction of a battery. The non-aqueous organic solvent may be a carbonate-based, ester-based, ether-based, ketone-based, or alcohol-based solvent, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, or the like. The ether-based solvent may be dibutyl ether, tetraglyme, diglyme, dimethoxyethane, 2-methyltetrahydrofuran, tetrahydrofuran, or the like and the ketone-based solvent may be cyclohexanone, or the like. In addition, the alcohol-based solvent may be ethyl alcohol, isopropyl alcohol, etc. and the aprotic solvent may be nitriles such as R—CN (where R may be a C2 to C20 linear, branched, or cyclic hydrocarbon group and may include a double bond, an aromatic ring, or an ether bond), amides such as dimethylformamide, dioxolanes such as 1,3-dioxolane, sulfolanes, or the like.

The non-aqueous organic solvent may be used alone or in a mixture. If the organic solvent is used in a mixture, the mixture ratio may be controlled in accordance with a desirable battery performance, which is widely understood by those skilled in the art.

In addition, in the case of the carbonate-based solvent, a mixture of a cyclic carbonate and a chain carbonate may be used. In this case, if the cyclic carbonate and the chain carbonate are mixed in a volume ratio of about 1:1 to about 1:9, the electrolyte may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

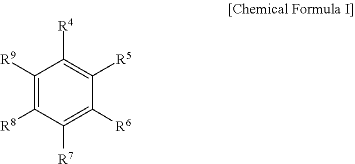

In Chemical Formula I, R⁴ to R⁹ may be the same or different and may be, e.g., hydrogen, a halogen, a C1 to C10 alkyl group, a haloalkyl group, or a combination thereof.

Specific examples of the aromatic hydrocarbon-based solvent may be, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate or an ethylene carbonate-based compound of Chemical Formula II in order to improve cycle-life of a battery.

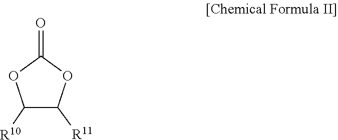

In Chemical Formula II, R¹⁰ and R¹¹ may be the same or different, and may be, e.g., hydrogen, a halogen, a cyano group, a nitro group, and a fluorinated C1 to C5 alkyl group, provided that at least one of R¹⁰ and R¹¹ is selected from a halogen, a cyano group, a nitro group, and fluorinated C1 to C5 alkyl group, but both of R¹⁰ and R¹¹ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolved in the non-organic solvent may supply lithium ions in a battery, enable a basic operation of a rechargeable lithium battery, and improve transportation of the lithium ions between positive and negative electrodes.

Examples of the lithium salt include, e.g., LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y may be natural numbers, e.g., an integer ranging from 1 to 20), lithium difluoro(bisoxolato) phosphate, LiCl, LiI, LiB(C₂O₄)₂ (lithium bis(oxalato) borate; LiBOB), or lithium difluoro(oxalato)borate (LiDFOB).

The lithium salt may be used in a concentration ranging from about 0.1 M to about 2.0 M. If the lithium salt is included at the above concentration range, an electrolyte may have excellent performance and lithium ion mobility due to optimal electrolyte conductivity and viscosity.

Rechargeable lithium batteries may be classified as lithium ion batteries, lithium ion polymer batteries, and lithium polymer batteries according to the presence of a separator and the type of electrolyte used therein. The rechargeable lithium batteries may have a variety of shapes and sizes, and include cylindrical, prismatic, coin, or pouch-type batteries, and may be thin film batteries or may be rather bulky in size. Structures and manufacturing methods for lithium ion batteries pertaining to this disclosure are well known in the art.

Hereinafter, examples and comparative examples are described. It is to be understood, however, that the examples are for the purpose of illustration and are not to be construed as limiting the present disclosure.

### EXAMPLE 1

### (1) Preparation of Negative Electrode Active Material Composite

Silicon particles with a micrometer size were pulverized through a wet process and obtained as nano particles satisfying conditions shown in Table 1. Subsequently, 55 g of the silicon nanoparticles of Table 1 was mixed with 5 g of crystalline carbon fibers simultaneously satisfying Tables 2 and 3 and then, processed in a spray drying method, preparing a spherical mixture. The spherical mixture was mixed with 40 g of pitch as an amorphous carbon precursor and then, heat-treated at 950° C. under a N₂ atmosphere. The heat-treated composite with a pellet shape was treated with a grinding classifier to adjust a particle size into 10 μm, preparing a negative electrode active material composite of Example 1.

### (2) Manufacture of Negative Electrode

13.5 wt % of the negative electrode active material, 83.5 wt % of general natural graphite, 0.5 wt % of denka black, 1.0 wt % of carboxylmethyl cellulose, and 1.5 wt % of a styrenebutadiene rubber were mixed in a water solvent, preparing negative electrode active material slurry having negative capacity of 500 mAh/g. The prepared negative electrode active material slurry was coated on both surfaces of a 10 μm-thick copper foil and then, dried, forming a negative electrode active material layer at a loading level of 33 mg/cm². Herein, a method of coating the negative electrode active material slurry was a die coating.

Subsequently, the coated foil was roll-pressed with a roll press machine under an electrode plate density condition of 1.65 g/cc, manufacturing a negative electrode having a total thickness of 132 μm.

### (3) Manufacture of Positive Electrode

97.5 wt % of an NCA-based positive electrode active material (an Ni content: 91%) as a positive electrode active material, 1.1 wt % of polyvinylidene fluoride as a binder, and 1.4 wt % of pre-dispersion of ketjen black as a conductive material were mixed in an N-methylpyrrolidone solvent, preparing positive electrode active material slurry. The positive electrode active material slurry was coated at a loading level of 76 mg/cm² on one surface of an aluminum current collector with a thickness: 13.5 μm and then, dried, forming a positive electrode active material layer. Herein, a method of coating the positive electrode active material slurry was the die coating.

Subsequently, the coated current collector was roll-pressed with a roll press machine under an electrode plate density condition of 3.65 g/cc, forming a positive electrode having a total thickness of 135 μm.

### (4) Manufacture of Battery Cell (Pouch-Type)

A polyethylene separator with a width of 76.5 mm, a length of 48.0 mm, and a thickness of 14 μm was inserted between the negative electrode and the positive electrode and assembled therewith. Herein, the coated surface of the negative electrode was in contact with the separator.

The electrode assembly was put into a pouch, and an electrolyte solution prepared by adding 1.10 M LiPF₆ lithium salt to a mixed solvent of ethylene carbonate and diethyl carbonate in a volume ratio of 50:50, manufacturing a rechargeable lithium battery cell.

### (5) Manufacture of Battery Cell (CR2032 Coin Full Cell Type)

A polyethylene separator with a width of 76.5 mm, a length of 48.0 mm, and a thickness of 14 μm was inserted between the negative electrode and the positive electrode and assembled therewith. Herein, the coated surface of the negative electrode was in contact with the separator.

The electrode assembly was manufactured as a coin-type full cell (CR2032 type) with a diameter of 12 mm, and an electrolyte solution prepared by adding 1.10 M LiPF₆ lithium salt to a mixed solvent of ethylene carbonate and diethyl carbonate in a volume ratio of 50:50, manufacturing a rechargeable lithium battery cell.

### EXAMPLE 2

A negative electrode active material composite, a negative electrode, and a rechargeable lithium battery cell were manufactured in the same manner as in Example 1 except that 10 g of the crystalline carbon fibers and 35 g of the pitch were used.

### EXAMPLE 3

A negative electrode active material composite, a negative electrode, and a rechargeable lithium battery cell were manufactured in the same manner as in Example 1 except that 20 g of the crystalline carbon fibers and 25 g of the pitch were used.

### EXAMPLE 4

A negative electrode active material composite, a negative electrode, and a rechargeable lithium battery cell were manufactured in the same manner as in Example 1 except that crystallinity of the crystalline carbon fibers was changed as shown in Table 3.

### EXAMPLE 5

A negative electrode active material composite, a negative electrode, and a rechargeable lithium battery cell were manufactured in the same manner as in Example 1 except that crystallinity of the crystalline carbon fibers was changed as shown in Table 3, and 10 g of the crystalline carbon fibers with the changed crystallinity and 35 g of the pitch were used.

### COMPARATIVE EXAMPLE 1

A negative electrode active material composite, a negative electrode, and a rechargeable lithium battery cell were manufactured in the same manner as in Example 1 except that the silicon nanoparticles were not used to manufacture the negative electrode composite.

### COMPARATIVE EXAMPLE 2

A negative electrode active material composite, a negative electrode, and a rechargeable lithium battery cell were manufactured in the same manner as in Example 1 except that the crystalline carbon fibers were not used to manufacture the negative electrode composite.

### COMPARATIVE EXAMPLE 3

A negative electrode active material composite, a negative electrode, and a rechargeable lithium battery cell were manufactured in the same manner as in Example 1 except that the crystalline carbon fibers were changed into graphite to manufacture the negative electrode composite.

### COMPARATIVE EXAMPLE 4

A negative electrode active material composite, a negative electrode, and a rechargeable lithium battery cell were manufactured in the same manner as in Example 1 except that the crystalline carbon fibers were changed into semi-crystalline or amorphous carbon fibers to manufacture the negative electrode composite.

### COMPARATIVE EXAMPLE 5

A negative electrode active material composite, a negative electrode, and a rechargeable lithium battery cell were manufactured in the same manner as in Example 1 except that the crystalline carbon fibers were changed into semi-crystalline or amorphous carbon fibers to manufacture the negative electrode composite, and the semi-crystalline or amorphous carbon fibers were in contact with the silicon nanoparticles.

TABLE 1

| | Silicon nanoparticles | | | | |
|---|---|---|---|---|---|
| | | | | | XRD full width |
| | | D₅₀ | Dmax | Aspect | at half |
| | Shape | (nm) | (nm) | ratio | maximum (°) |
| Comp. Ex. 1 | — | — | — | — | — |
| Comp. Ex. 2 | flake | 100 | 260 | 10 | 0.97 |
| Comp. Ex. 3 | flake | 100 | 260 | 10 | 0.97 |
| Comp. Ex. 4 | flake | 100 | 260 | 10 | 0.97 |
| Comp. Ex. 5 | flake | 100 | 260 | 10 | 0.97 |
| Example 1 | flake | 100 | 260 | 10 | 0.97 |
| Example 2 | flake | 100 | 260 | 10 | 0.97 |
| Example 3 | flake | 100 | 260 | 10 | 0.97 |
| Example 4 | flake | 100 | 260 | 10 | 0.97 |
| Example 5 | flake | 100 | 260 | 10 | 0.97 |

TABLE 2

| | Crystalline carbon fibers or graphite | | | | |
|---|---|---|---|---|---|
| | | D₅₀ | Dmax | Aspect | Thickness |
| | Shape | (μm) | (μm) | ratio | (nm) |
| Comp. Ex. 1 | Fiber type | 2 | 5 | 30 | 95 |
| Comp. Ex. 2 | — | — | — | — | — |
| Comp. Ex. 3 | Graphite | 12 | 20 | 1.5 | — |
| Comp. Ex. 4 | Fiber type | 0.2 | 1 | 50 | 20 |
| Comp. Ex. 5 | Fiber type | 0.2 | 1 | 50 | 20 |
| Example 1 | Fiber type | 2 | 5 | 30 | 95 |
| Example 2 | Fiber type | 2 | 5 | 30 | 95 |
| Example 3 | Fiber type | 2 | 5 | 30 | 95 |
| Example 4 | Fiber type | 1 | 3 | 30 | 70 |
| Example 5 | Fiber type | 1 | 3 | 30 | 70 |

TABLE 3

Crystalline carbon fibers or graphite

| | d002 (nm) | I_{D}/I_{G} |
|---|---|---|
| Comp. Ex. 1 | 3.361 | 0.2 |
| Comp. Ex. 2 | — | — |
| Comp. Ex. 3 | 3.358 | 0.1 |
| Comp. Ex. 4 | 3.862 | 1.1 |
| Comp. Ex. 5 | 3.862 | 1.1 |
| Ex. 1 | 3.361 | 0.2 |
| Ex. 2 | 3.361 | 0.2 |
| Ex. 3 | 3.361 | 0.2 |
| Ex. 4 | 3.364 | 0.5 |
| Ex. 5 | 3.364 | 0.5 |

### EVALUATION EXAMPLE 1

### Appearance Evaluation of Negative Electrode Active Material Composite

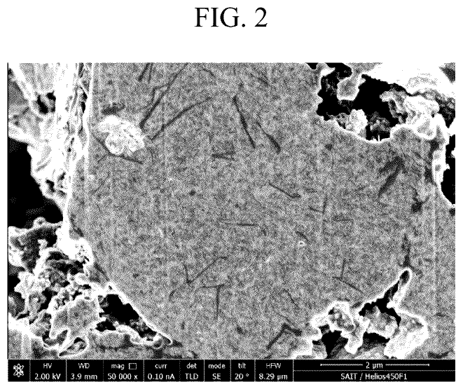

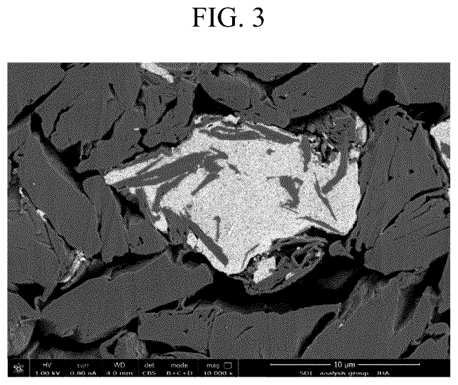

Each of the negative electrode active material composites of Example 1 and Comparative Example 3 was taken an SEM image of by using an SEM device (product name: S4800, manufacturer: Hitachi, Ltd.) in an SE mode, and the images are shown in FIGS. 2 and 3.

### EVALUATION EXAMPLE 2

### Evaluation of Physical Properties of Negative Electrode Active Material Composite

The negative electrode active material composites according to Examples 1 to 5 and Comparative Examples 1 to 5 were evaluated in the following method, and the evaluation results are shown in Table 4.

In order to analyze an internal pores volume, a pore size, and BET, an N₂ adsorption analysis equipment was used, and a sample was filled to a half or more of a volume of a round flask-shaped tube and vacuum-dried to remove moisture. After mounting the tube containing the sample from which the moisture was removed on the N₂ adsorption analysis equipment and then, filling liquid nitrogen to ⅔ or more of the tube, the sample was analyzed.

In addition, a particle size analyzer of a Laser diffraction method was used for the analysis. About 1 g of the sample was put in a vial and then, diluted in DIW. After the dilution, the sample was loaded in the particle size analyzer over 1 minute with a pipette, wherein the loading was performed under ultrasonic waves dispersion, and when the loading was completed, after also turning off the ultrasonic wave dispersion, the sample was analyzed.

TABLE 4

| | Negative electrode active material composite | | | | | | |
|---|---|---|---|---|---|---|---|
| | | Content of | | | | | |
| | Content of | crystalline | Pore | Pore | | | |
| | silicon | carbon fibers | volume | size | BET | D₅₀ | Dmax |
| | (wt %) | (wt %) | (cm³/g) | (nm) | (m²/g) | (μm) | (μm) |
| Comp. Ex. 1 | 0 | 100 | 10 | 10 | 40 | 2 | 4 |
| Comp. Ex. 2 | 100 | 0 | 0.005 | 10 | 2 | 10 | 15 |
| Comp. Ex. 3 | 90 | 10 | 0.2 | 80 | 8 | 10 | 20 |
| Comp. Ex. 4 | 90 | 10 | 0.05 | 10 | 1.5 | 10 | 15 |
| Comp. Ex. 5 | 90 | 10 | 0.05 | 10 | 1.5 | 10 | 15 |
| Ex. 1 | 95 | 5 | 0.005 | 10 | 1.3 | 10 | 15 |
| Ex. 2 | 90 | 10 | 0.008 | 10 | 1.3 | 10 | 15 |
| Ex. 3 | 80 | 20 | 0.01 | 10 | 1.3 | 10 | 15 |
| Ex. 4 | 95 | 5 | 0.005 | 10 | 1.3 | 10 | 15 |
| Ex. 5 | 90 | 10 | 0.008 | 10 | 1.3 | 10 | 15 |

### EVALUATION EXAMPLE 3

### Evaluation of Electrochemical Characteristics of Rechargeable Lithium Battery Cells

For each rechargeable lithium battery cell manufactured in Examples 1 to 5 and Comparative Examples 1 to 5, electrochemical characteristics were evaluated in the following manner, and the results are shown in Table 5.
(1) Thickness expansion rate of negative electrode: A rechargeable lithium battery cell in the form of a pouch cell was charged with a constant current to 4.2 V at a rate of 0.5 C, and discharged with a constant current to 2.5 V at a rate of 0.5 C. This charge and discharge characteristic experiment was repeated to 100 cycles. While the charging and discharging were performed, an expansion rate of each of the negative electrodes in-situ was evaluated through a thickness measuring system. The expansion rate was defined according to Equation 1.

$$Negative electrode thickness expansion rate [ \% ] = \qquad [ Equation 1 ]$$

$$[ negative electrode thickness after 100 cycles /$$

$$negative electrode thickness at first cycle ] \times 100$$

(2) Initial efficiency of rechargeable lithium battery cell: A R2032 coin full cell type rechargeable lithium battery cell was once charged and discharged at 0.1 C for formation and then, checked with respect to initial charge and discharge characteristics in the formation step, and the results are shown in Table 5. Initial efficiency was defined according to Equation 2.

$$Initial efficiency ( \% ) = ( discharge capacity ( formation ) at first cycle ) / ( charge capacity ( formation ) at first cycle ) \times 100 \qquad [ Equation 2 ]$$

(3) Cycle-life (capacity retention) of rechargeable lithium battery cell: A R2032 coin full cell rechargeable lithium battery cell was charged at 0.1 C and discharged at 0.1 C for initial formation. When the initial formation was completed, the cell was constant current-charged to 4.0 V at a rate of 1.0 C and constant current-discharged to 2.5 V at a rate of 1.0 C. This charge and discharge characteristic experiment was repeated to 200 cycles. The cycle-life characteristics were defined according to Equation 3.

$$Capacity retention [ \% ] = \qquad [ Equation 3 ]$$

$$[ Discharge capacity after 200 cycles ( 1. C ) /$$

$$Discharge capacity at first cycle ( 1. C ) ] \times 100$$

TABLE 5

| | | | Negative |
|---|---|---|---|
| | Rechargeable lithium battery cells | | electrodes |
| | Initial | | Thickness |
| | efficiency | Cycle-life | expansion rate |
| | (F.C.E, %) | (%, @200 cyc) | (%, @100 cyc) |
| Comp. Ex. 1 | 70 | — | — |
| Comp. Ex. 2 | 85 | 70 | 17 |
| Comp. Ex. 3 | 87 | Sudden drop | 35 |
| Comp. Ex. 4 | 83 | 75 | 18 |
| Comp. Ex. 5 | 83 | 65 | 18 |
| Ex. 1 | 87 | 87 | 17 |
| Ex. 2 | 87 | 87 | 17 |
| Ex. 3 | 86 | 86 | 17 |
| Ex. 4 | 87 | 86 | 17 |
| Ex. 5 | 87 | 85 | 17 |

Each of the negative electrode active material composite of Examples 1 to 5 included an amorphous carbon matrix; and silicon nanoparticles and crystalline carbon fibers dispersed in the amorphous carbon matrix, wherein the silicon nanoparticles were present in contact with a portion or all of the crystalline carbon fibers in the amorphous carbon matrix.

For example, referring to FIGS. 2 and 3, an amorphous silicon carbon composite of 10 μm or so was found, and the rest was mixed natural graphite. When the SEM images were enlarged in the SE mode to examine the inside of the silicon carbon composite, a gray shape in a bright lit region indicates silicon nanoparticles, and a region appearing black indicates graphite (FIG. 3) or crystalline carbon fibers (FIG. 2). The crystalline carbon fibers were in contact with the grayish silicon nanoparticles.

Referring to Tables 4 and 5, compared with the rechargeable lithium battery cells of Comparative Examples 1 to 5, the rechargeable lithium battery cells of Examples 1 to 5 exhibited excellent characteristics.

For example, in Table 5, the crystalline carbon fibers of Comparative Example 1 had a side reaction due to porosity, which failed in properly evaluating a battery cycle-life. Comparative Example 2, in which the negative electrode composite was formed of the silicon nanoparticles and the amorphous carbon alone after removing the crystalline carbon fibers or the graphite, exhibited reduced initial efficiency and particularly, 70% of a cycle-life at the 200 cycles, as an initial cycle-life slope sharply decreased due to low electrical conductivity, but when the graphite was used instead of the crystalline carbon fibers, excellent initial efficiency of 87% was achieved, but an expansion rate increased due to increased pores by the graphite, and the cycle-life also did not reach 200 cycles but sharply dropped. When the crystalline carbon fibers were replaced with the semi-crystalline general carbon fibers, initial efficiency decreased, and electrical conductivity also decreased, deteriorating a cycle-life. On the contrary, the negative electrode active material composites of the examples, in which the silicon nanoparticles were combined with the crystalline carbon fibers, exhibited similar initial efficiency and expansion rate to those of a composite, in which the silicon nanoparticles alone were used, and since the crystalline carbon fibers with high electrical conductivity increased an initial cycle-life slope, a cycle-life improved to 87% at 200 cycles.

By way of summation and review, there may be problems with using non-carbon-based negative electrode active materials in that the non-carbon-based negative electrode active material may have a severe volume change due to charging and discharging, and a solid electrolyte interface (SEI), a type of passivation film, may be formed at the interface with the electrolyte in the process of volume change of the non-carbon-based negative electrode active material, and compared to the carbon-based negative electrode active material, cycle-life of a rechargeable lithium battery may be drastically reduced or shortened.

In addition, because the non-carbon-based negative electrode active material may have low electrical conductivity, it may be difficult to secure high rate and output characteristics of a rechargeable lithium battery if used alone as a negative electrode active material.

The present disclosure relates to a negative electrode active material composite that can simultaneously secure capacity characteristics, rate capability, and cycle-life characteristics of a rechargeable lithium battery, and a negative electrode and a rechargeable lithium battery including the same.

The negative electrode active material of the embodiments can implement a rechargeable lithium battery having excellent capacity characteristics, rate capability, and cycle-life characteristics, compared with a case where silicon nanoparticles are used alone or if silicon nanoparticles are used in combination with graphite.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material composite, comprising:
an amorphous carbon matrix; and
silicon nanoparticles and crystalline carbon fibers dispersed in the amorphous carbon matrix, and
the silicon nanoparticles being in contact with a portion or all of the crystalline carbon fibers in the amorphous carbon matrix.

2. The negative electrode active material composite as claimed in claim 1, wherein an average particle diameter (D₅₀) of the silicon nanoparticles is about 50 nm to about 200 nm, and a maximum particle diameter (Dₘₐₓ) is about 80 nm to about 300 nm.

3. The negative electrode active material composite as claimed in claim 1, wherein an aspect ratio of the silicon nanoparticles is about 1 to about 20.

4. The negative electrode active material composite as claimed in claim 1, wherein a full width at half maximum of an X-ray diffraction angle using CuKα ray at the (111) plane of the silicon nanoparticles is about 0.3° to about 1.0°.

5. The negative electrode active material composite as claimed in claim 1, wherein an average particle diameter (D₅₀) of the crystalline carbon fibers is about 0.5 μm to about 3.0 μm, and a maximum particle diameter (Dₘₐₓ) is about 3.0 μm to about 5.0 μm.

6. The negative electrode active material composite as claimed in claim 1, wherein an aspect ratio of the crystalline carbon fibers is about 5 to about 300.

7. The negative electrode active material composite as claimed in claim 1, wherein a thickness of the crystalline carbon fibers is about 10 nm to about 100 nm.

8. The negative electrode active material composite as claimed in claim 1, wherein when measured by XRD for the crystalline carbon fiber, an interplanar spacing d002 of the (002) plane is about 0.3354 nm to about 0.3365 nm.

9. The negative electrode active material composite as claimed in claim 1, wherein in Raman spectrum analysis of the crystalline carbon fiber, a peak intensity ratio (I_{D}/I_{G}) of a peak intensity (I_{D}) of a D peak (1350 to 1370 cm⁻¹) to a peak intensity (I_{D′}) of a G peak (1570 to 1620 cm⁻¹) is about 0.2 to about 0.5.

10. The negative electrode active material composite as claimed in claim 1, wherein the amorphous carbon matrix includes soft carbon, hard carbon, a mesophase pitch carbonized product, calcined coke, or a mixture thereof.

11. The negative electrode active material composite as claimed in claim 1, wherein the negative electrode active material composite includes the silicon nanoparticles and the crystalline carbon fibers in a weight ratio of greater than or equal to about 2.

12. The negative electrode active material composite as claimed in claim 1, wherein, based on a total weight of the negative electrode active material composite, the silicon nanoparticles are included in an amount of about 40 wt % to about 70 wt %, the crystalline carbon fibers are included in an amount of about 1 wt % to about 20 wt %, and the amorphous carbon matrix is included in an amount of about 10 wt % to about 50 wt %.

13. The negative electrode active material composite as claimed in claim 1, wherein an average particle diameter (D₅₀) of the negative electrode active material composite is about 7 μm to about 15 μm, and a maximum particle diameter (Dₘₐₓ) is about 10 μm to about 30 μm.

14. The negative electrode active material composite as claimed in claim 1, wherein an internal pore diameter of the negative electrode active material composite is about 5 nm to about 50 nm.

15. The negative electrode active material composite as claimed in claim 1, wherein a BET specific surface area of the negative electrode active material composite is about 0.1 m²/g to about 5 m²/g.

16. A method of manufacturing a negative electrode active material composite, the method comprising:
mixing silicon nanoparticles with crystalline carbon fibers thereby creating a mixture;
processing the mixture into a silicon nanoparticle-crystalline carbon fiber composite precursor; and
heat-treating the silicon nanoparticle-crystalline carbon fiber composite precursor and an amorphous carbon precursor in a nitrogen atmosphere to manufacture the negative electrode active material composite.

17. A negative electrode for a rechargeable lithium battery, the negative electrode comprising a current collector and a negative electrode active material layer on the current collector,
the negative electrode active material layer including the negative electrode active material composite as claimed in claim 1.

18. The negative electrode as claimed in claim 17, wherein if a rechargeable lithium battery including the negative electrode is subjected to 100 cycles as one cycle of charging with a constant current to 4.2 V at a rate of 0.5 C and discharging with a constant current to 2.5 V at a rate of 0.5 C, the negative electrode has a thickness expansion rate of according to Equation 1 of less than or equal to about 20%, and
$$Negative electrode thickness expansion rate [ \% ] = \qquad [ Equation 1 ]$$
$$[ negative electrode thickness after 100 cycles /$$
$$negative electrode thickness at first cycle ] \times 100.$$

19. A rechargeable lithium battery, comprising:
a positive electrode;
a negative electrode; and
an electrolyte,
wherein the negative electrode is the negative electrode as claimed in claim 17.
